(19) United States
(12) Patent Application Publication
(10) Pub. No.: US 2012/0158480 A1
(43) Pub. Date: Jun. 21, 2012

(54) DYNAMIC VARIABLE DISCOUNT SYSTEM, METHOD AND COMPUTER PROGRAM PRODUCT

(75) Inventor: Venkatesh M. Sundaram, Flower Mound, TX (US)

(73) Assignee: IYER HOLDINGS, INC., Flower Mound, TX (US)

(21) Appl. No.: 13/316,151

(22) Filed: Dec. 9, 2011

Related U.S. Application Data
(60) Provisional application No. 61/424,076, filed on Dec. 17, 2010.

(51) Int. Cl. G06Q 30/02

(52) U.S. Cl. 705/14.23

(57) ABSTRACT

According to one aspect of the present disclosure, a system, method and technique for dynamic variable discounts is disclosed. The system includes: a shopping module executable by a processing unit to accumulate data corresponding to a shopping event of a consumer; and a discount module executable by a processing unit to evaluate data corresponding to the shopping event and dynamically determine a discount to be applied to at least one item selected by the consumer during the shopping event.

### BACKGROUND

Consumers utilize the Internet to shop for and purchase a variety of different types of products or items. Many vendor websites periodically offer certain items at a sales price (e.g., by reducing the sales price by some percentage). As an incentive for consumers to purchase products, vendors oftentimes send to consumers special promotion codes or other mailer items that the consumer may utilize for an additional discount at the time of purchase. For example, a vendor website may include an input entry location for the discount code to enable a price reduction at checkout.

### BRIEF SUMMARY

According to one aspect of the present disclosure a dynamic variable discount method and technique is disclosed. The system includes: a shopping module executable by a processing unit to accumulate data corresponding to a shopping event of a consumer; and a discount module executable by a processing unit to evaluate data corresponding to the shopping event and dynamically determine a discount to be applied to at least one item selected by the consumer during the shopping event.

According to another aspect of the present disclosure a dynamic variable discount method includes accumulating data corresponding to a website shopping event of a consumer; storing the shopping event data in memory; and responsive to receiving a discount request by the consumer, dynamically determining a discount to be applied to at least one item selected by the consumer during the shopping event.

### BRIEF DESCRIPTION OF THE SEVERAL VIEWS OF THE DRAWINGS

For a more complete understanding of the present application, the objects and advantages thereof, reference is now made to the following descriptions taken in conjunction with the accompanying drawings, in which:

FIG. 1 is an embodiment of a network of data processing systems in which the illustrative embodiments of the present disclosure may be implemented;

FIG. 2 is an embodiment of a data processing system in which the illustrative embodiments of the present disclosure may be implemented;

FIG. 3 is a diagram illustrating an embodiment of a data processing system for a dynamic variable discount system in which illustrative embodiments of the present disclosure may be implemented;

FIG. 4 is a flow diagram illustrating an embodiment of a dynamic variable discount method according to the present disclosure.

### DETAILED DESCRIPTION

Embodiments of the present disclosure provide a method and technique for a dynamic variable discount system. For example, in some embodiments, the system and technique includes: a shopping module executable by a processing unit to accumulate data corresponding to a shopping event of a consumer; and a discount module executable by a processing unit to evaluate data corresponding to the shopping event and dynamically determine a discount to be applied to at least one item selected by the consumer during the shopping event. Embodiments of the present disclosure enable discounts for product items to be dynamically calculated and/or selected based on a variety of factors or variables that may include, for example, current and past consumer behavior, inventory levels of different products items, the combination of product items selected for purchase by the consumer, and the rate of sales of different product items. Thus, embodiments of the present disclosure provide a discount determination technique that adapts to various types criteria (e.g., past events and/or current real time information).

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon. Any combination of one or more computer usable or computer readable medium(s) may be utilized. The computer readable medium may be a computer readable signal medium or a computer readable storage medium. A computer readable storage medium may be, for example but not limited to, an electronic, magnetic, optical, electromagnetic, infrared, or semiconductor system, apparatus, or device, or any suitable combination of the foregoing. More specific examples of the computer readable storage medium may include, but not be limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

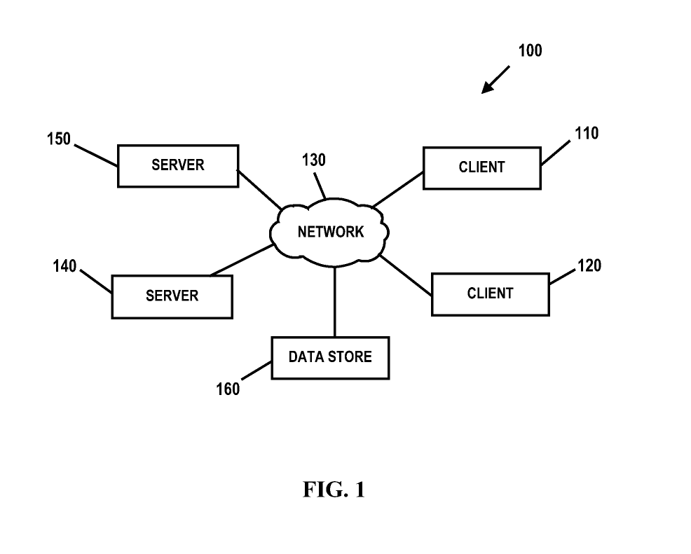

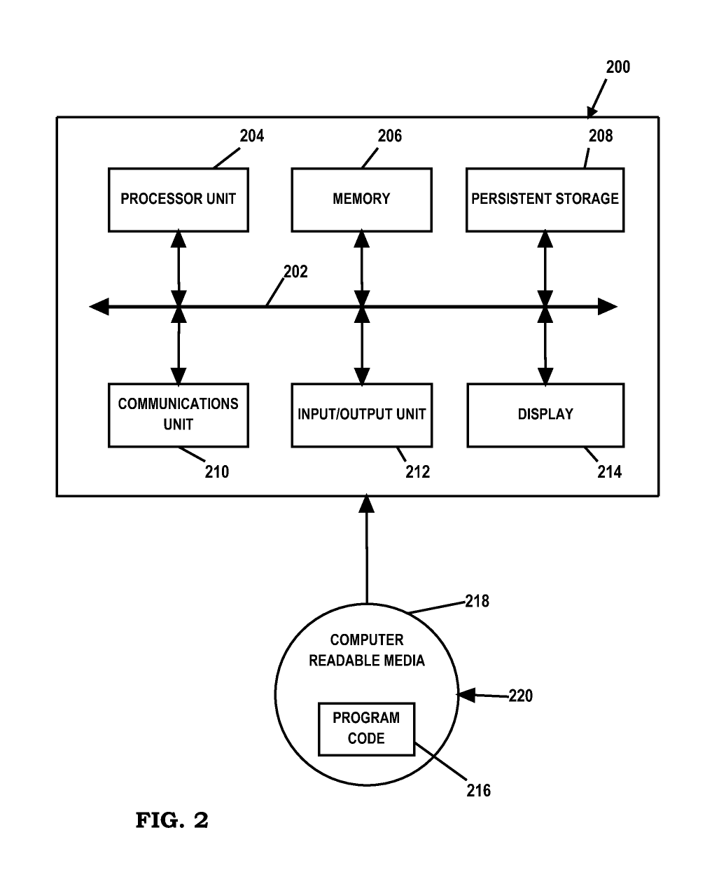

With reference now to the Figures and in particular with reference to FIGS. 1-2, exemplary diagrams of data processing environments are provided in which illustrative embodiments of the present disclosure may be implemented. It should be appreciated that FIGS. 1-2 are only exemplary and are not intended to assert or imply any limitation with regard to the environments in which different embodiments may be implemented. Many modifications to the depicted environments may be made.

FIG. 1 is a pictorial representation of a network of data processing systems in which illustrative embodiments of the present disclosure may be implemented. Network data processing system 100 is a network of computers in which the illustrative embodiments of the present disclosure may be implemented. Network data processing system 100 contains network 130, which is the medium used to provide communications links between various devices and computers connected together within network data processing system 100. Network 130 may include connections, such as wire, wireless communication links, or fiber optic cables.

In some embodiments, server 140 and server 150 connect to network 130 along with data store 160. In addition, clients 110 and 120 connect to network 130. Clients 110 and 120 may be, for example, personal computers, network computers or other types of personal computing devices (e.g., smartphones, personal digital assistants, etc.). In the depicted example, servers 140 and/or 150 provide data and/or services such as, but not limited to, data files, operating system images, and applications to clients 110 and 120. Network data processing system 100 may include additional servers, clients, and other devices.

In the depicted example, network data processing system 100 is the Internet with network 130 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

FIG. 2 is an embodiment of a data processing system 200 such as, but not limited to, client 110 and/or server 140 in which an embodiment of a variable discount system according to the present disclosure may be implemented. In this embodiment, data processing system 200 includes a bus or communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

In some embodiments, memory 206 may be a random access memory or any other suitable volatile or non-volatile storage device. Persistent storage 208 may take various forms depending on the particular implementation. For example, persistent storage 208 may contain one or more components or devices. Persistent storage 208 may be a hard drive, a flash memory, a rewritable optical disk, a rewritable magnetic tape, or some combination of the above. The media used by persistent storage 208 also may be removable such as, but not limited to, a removable hard drive.

Communications unit 210 provides for communications with other data processing systems or devices. In these examples, communications unit 210 is a network interface card. Modems, cable modem and Ethernet cards are just a few of the currently available types of network interface adapters. Communications unit 210 may provide communications through the use of either or both physical and wireless communications links.

Input/output unit 212 enables input and output of data with other devices that may be connected to data processing system 200. In some embodiments, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer readable media 218 may not be removable. Alternatively, program code 216 may be transferred to data processing system 200 from computer readable media 218 through a communications link to communications unit 210 and/or through a connection to input/output unit 212. The communications link and/or the connection may be physical or wireless in the illustrative examples.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. For example, a storage device in data processing system 200 is any hardware apparatus that may store data. Memory 206, persistent storage 208, and computer readable media 218 are examples of storage devices in a tangible form.

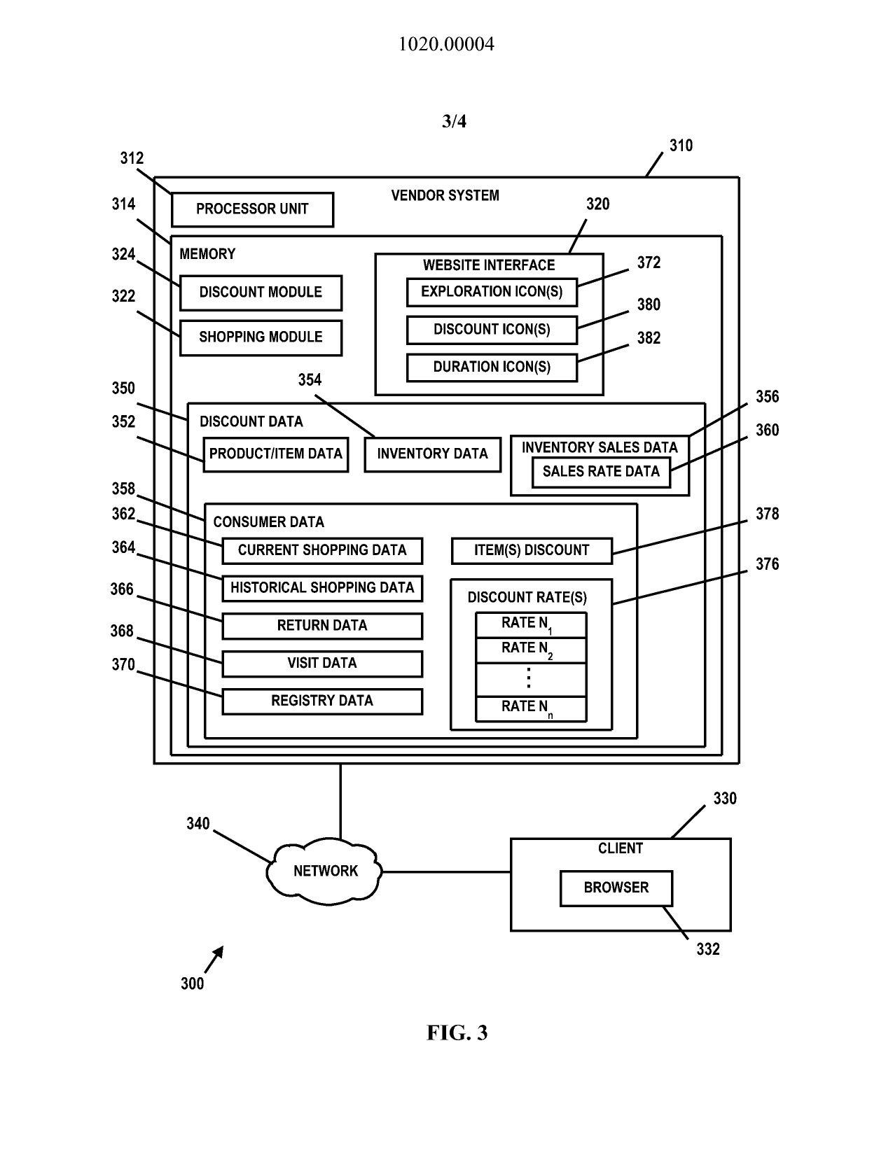

FIG. 3 is an illustrative embodiment of a variable discount system 300 in accordance with the present disclosure. System 300 may be implemented on data processing systems or platforms such as, but not limited to, client 110, server 140 or at other data processing system locations. In FIG. 3, system 300 includes a product provider or vendor system 310 having a processor unit 312 and a memory 314. In general, processor unit 312 processes and/or executes instructions (e.g., software code) and performs logic functions and/or calculations while memory 314 temporarily or permanently stores information that may be retrieved therefrom. In some embodiments, vendor system 310 is configured to enable Internet- or web-based shopping for different types of products by a consumer. However, it should be understood that various aspects of the present disclosure may be incorporated into non-Internet or non-website shopping.

In FIG. 3, memory 314 includes a website interface 320, a shopping module 322 and a discount module 324. Website interface 320, shopping module 322 and discount module 324 may be implemented in any suitable manner that may be hardware-based, software-based, or some combination of both. For example, interface 320 and/or modules 322 and 324 may comprise software, logic and/or executable code for performing various functions as described herein (e.g., residing as software and/or an algorithm running on a processor unit, hardware logic residing in a processor or other type of logic chip, centralized in a single integrated circuit or distributed among different chips in a data processing system). In some embodiments, interface 320 and/or modules 322 and 324 are software (e.g., a set of instructions and/or an algorithm) that, when executed by processor unit 312, perform various functions as described herein.

Website interface 320 is used to generate and/or otherwise provide an Internet- or web-based display interface for a shopping experience by a consumer. For example, in some embodiments, a consumer may utilize a client system 330 having a browser 332 capable of accessing and/or otherwise communicating with vendor system 310 over a network 340. Website interface 320 may generate and/or otherwise display one or more website pages indicating items available for purchase by the consumer, website pages for conducting a purchase of one or more items, etc. Shopping module 322 may be used to store, calculate and/or otherwise keep track of items selected for purchase by a customer (e.g., a shopping cart function) during a shopping event (e.g., a communication session between client 330 and vendor system 310). Discount module 324 is configured to dynamically determine and/or select a discount rate to apply to one or more items selected by the consumer for purchase (e.g., applied to a single item, multiple items, applied toward a total purchase price, etc.) based on one or more different variables such that a discount applicable to one consumer may vary from a discount offered to another consumer. The discount may also vary based on a time of the shopping event, the duration of the shopping event, the particular items selected for purchase by the consumer, the particular combination of items selected for purchase by the consumer, the consumer's prior shopping history (e.g., purchases and/or returns), and/or various other factors. Thus, embodiments of the present disclosure enable different criteria and/or variables to be used to dynamically derive and/or select a discount to be applied to a purchase made by the consumer.

In the embodiment illustrated in FIG. 3, memory 314 includes discount data 350 comprising information associated with a shopping event of a consumer and/or information used to derive/determine a discount to apply to a shopping event of a consumer. For example, in FIG. 3, discount data 350 includes product data 352, inventory data 354, inventory sales data 356, and consumer data 358. Product data 352 comprises information associated with the different products available for purchase from a vendor. For example, product data 352 may include descriptive information regarding a product item, a sales price, an image depicting the item, etc. Various portions of product data 352 may be displayed to a consumer via website interface 320. Inventory data 354 comprises information associated with an inventory or availability of a particular product item for purchase by a consumer (e.g., a quantity of item units in stock and available for purchase). Inventory sales data 356 comprises information associated with sales of a particular product item. For example, in some embodiments, inventory sales data 356 may comprise sales rate data 360 comprising information pertaining to a rate of sales of a particular item (e.g., a quantity of item units sold over a certain time period).

Consumer data 358 comprises information associated with a particular consumer conducting a shopping event via vendor system 310. In the embodiment illustrated in FIG. 3, consumer data 358 includes current shopping data 362, historical shopping data 364, return data 366, visit data 368 and registry data 370. Current shopping data 362 comprises information associated with current shopping event activity performed and/or conducted by a consumer utilizing vendor system 310. For example, current shopping data 362 may include information associated with various products selected for purchase by the consumer and placed in a shopping cart as processed by shopping module 322. Historical shopping data 364 may comprise information associated with past or previous shopping events for a particular consumer. For example, vendor system 310 may be configured to enable a consumer to login as a registered consumer such that previous billing information, shipping address information, and the like, may be automatically loaded into and/or used for the current shopping event. Historical shopping data 364 may include information associated with previous purchases made by the particular consumer, items viewed by the consumer, items placed in and/or removed from a shopping cart, etc. Return data 366 may comprise information associated with product item returns made by the consumer. For example, return data 366 may include information associated with items that were previously purchased by the consumer but returned to the vendor for various reasons. Visit data 368 may comprise information associated with a consumer's access to the shopping site by vendor system 310. For example, in some embodiments, visit data 368 may include the particular website pages visited by the consumer, the time or duration spent on each website page and/or the shopping event in its entirety, the time or duration spent evaluating a particular item, etc. Visit data 368 may also include information associated with different exploration icons 372 clicked on by a consumer visiting vendor system 310. For example, website interface 320 may be configured to locate and/or display various types and/or quantities of clickable exploration icons 372 on various website pages of vendor system 310 such that the consumer is prompted to search for and click on such exploration icons 372 to increase a discount amount applicable to a shopping purchase.

Visit data 368 may relate to a current shopping event and/or previous or historical shopping events. Registry data 370 may comprise information associated with a personal gift registry registered by the user with vendor system 310. For example, the gift registry may relate to a wedding event or a holiday. Registry data 370 may include various product items corresponding to the consumer registering the registry of product items for other persons.

In the embodiment illustrated in FIG. 3, discount data 350 also includes discount rate(s) 376 and item(s) discount 378. Discount rate(s) 376 may comprise one or more different discount rates that may be selected and/or applied by discount module 324 for certain items selected for purchase by the consumer. For example, discount rate(s) 376 may comprise relational information correlating certain discount rates to certain items or combinations of items. In some embodiments, discount rate(s) 376 may comprise predefined discount percentages that may be applied to a purchase price of an item or combination of items. However, it should also be understood that in some embodiments, discount module 324 may calculate and/or otherwise derive a discount rate 376 to apply to a purchase price of an item or combination of items. For example, in some embodiments, discount module 324 may comprise an algorithm for calculating a discount rate 376 based on one or more criteria (e.g., criteria and/or variables as represented by discount data 350). Discount module 324 may select a particular discount rate 376 for one item and a different discount rate 376 for another item (or combinations of items). Discount module 324 may also select a particular discount rate 376 for one consumer and a different discount rate 376 for another consumer. Item(s) discount 378 may comprise information associated with particular items that have a variable discount associated therewith. For example, item(s) discount 378 may include an identification of certain items that discount module 324 will determine/select a particular discount rate 376 to apply. In some embodiments, website interface 320 may be configured to display to a prospective consumer the product items that will have a discount applicable thereto. In some embodiments, item(s) discount 378 may identify certain items that may be the subject of a promotion or random giveaway (e.g., an increased discount rate 376 or free item).

In operation, discount module 324 accesses and analyzes/evaluates various discount data 350 to automatically and/or dynamically select and apply a discount rate to one or more items selected for purchase by a consumer for a shopping event. For example, in some embodiments, website interface 320 may generate and display a discount icon 380 that a consumer may click on or select. In response to receiving an input of discount icon 380 by a consumer indicating a request for a discount, discount module 324 accesses and analyzes/evaluates various discount data 350 to automatically and/or dynamically select and apply a discount rate to one or more items selected for purchase by a consumer for a shopping event. Discount icon 380 may comprise a spinning wheel, a random digital number display, or any other type of display element for providing the consumer with a visual indication of variable discount selection. Thus, for example, discount icon 380 may take the form of a wheel having a plurality of different discount rates imprinted thereon that spins and stops on one of the numbers indicating the offered discount. As another example, discount icon 380 may take the form of a visual display similar to a slot machine display where different numbers randomly appear or spin into a visible window and stop on a particular discount rate 376.

In some embodiments, discount module 324 is configured to determine and/or select a particular discount rate 376 based on variables and/or criteria such as a quantity of items contained in inventory as defined by inventory data 354. For example, a large quantity of items in inventory or a time period certain items have remained in inventory may result in a discount being applied or an increase in a discount rate correlated with a particular item. As inventory levels decrease, the discount rate 376 may be decreased and/or discontinued. In some embodiments, sales rate data 360 may be used to determine and/or select a particular discount rate 376. For example, if the rate of sales for a particular item is slow, discount module 324 may automatically increase the discount rate 376 to spur sales of the particular item. Correspondingly, as the rate of sales increases, discount module 324 may correspondingly automatically reduce the discount rate 376.

In some embodiments, discount module 324 is configured to determine and/or select a particular discount rate 376 based on consumer behavior during a current and/or previous shopping visit(s). For example, in some embodiments, discount module 324 may evaluate a quantity of shopping visits made by a particular consumer to the vendor's website, the quantity and/or price of previous purchases made by the consumer, the duration of previous and/or current shopping visits/events, item returns made by the consumer, or other factors such as set forth in visit data 368, return data 366 historical shopping data 364 and/or current shopping data 362. As an example, a greater quantity of shopping visits and/or past purchases made by the consumer may result in a greater discount rate 376 being selected/applied to a current shopping event. A high rate of returns by the consumer may correspondingly result in a lower or decreased discount rate 376. Further, longer durations of a shopping event by the consumer (e.g., current and/or previous shopping visit events) may result in a greater discount rate 376 being selected/determined by discount module 324. For example, as a time period for a particular shopping event increase, the discount rate 376 determined/selected by discount module 324 may also dynamically increase. The duration of the shopping event may be computed based on the current shopping event and/or in combination with previous shopping events. In some embodiments, website interface 320 may generate and display a duration icon 382 to visually indicate to a consumer a duration of the shopping visit/event, thereby providing the consumer with a visual indication of a possible increase in a discount rate 376 that may be applied by discount module 324. Duration icon 382 may comprise an inflating balloon image, an object that elevates in position on a website page, or other visual indication of visit duration. Additionally, as a quantity of items placed in the consumer's shopping cart as reflected by current shopping data 362 increases (e.g., based on a quantity of items and/or total sales price), the discount rate 376 determined/selected by discount module 324 may increase. Discount rate 376 may be determined/selected based on whether the consumer is a new consumer to the vendor's shopping site (e.g., a new consumer may be awarded a greater discount rate 376).

In some embodiments, discount module 324 may determine/select a particular discount rate 376 based on a quantity of exploration icons 372 discovered and clicked on by the consumer. For example, as an incentive to view different website pages, product items and/or locations of the vendor's website (e.g. a policy or guidelines website page), exploration icons 372 may be placed at various website page locations. In this example, the more exploration icons 372 discovered and clicked on by the consumer may result in a greater discount rate 376 being determined/selected by discount module 324.

In some embodiments, registry data 370 may be used to determine/select a particular discount rate 376. For example, in some embodiments, a consumer may be encouraged to create a gift or product item registry for the consumer, an acquaintance of the consumer, or some other third party. In response to a selection of an item from the registry, discount module 324 determines/selects a discount rate 376 to apply.

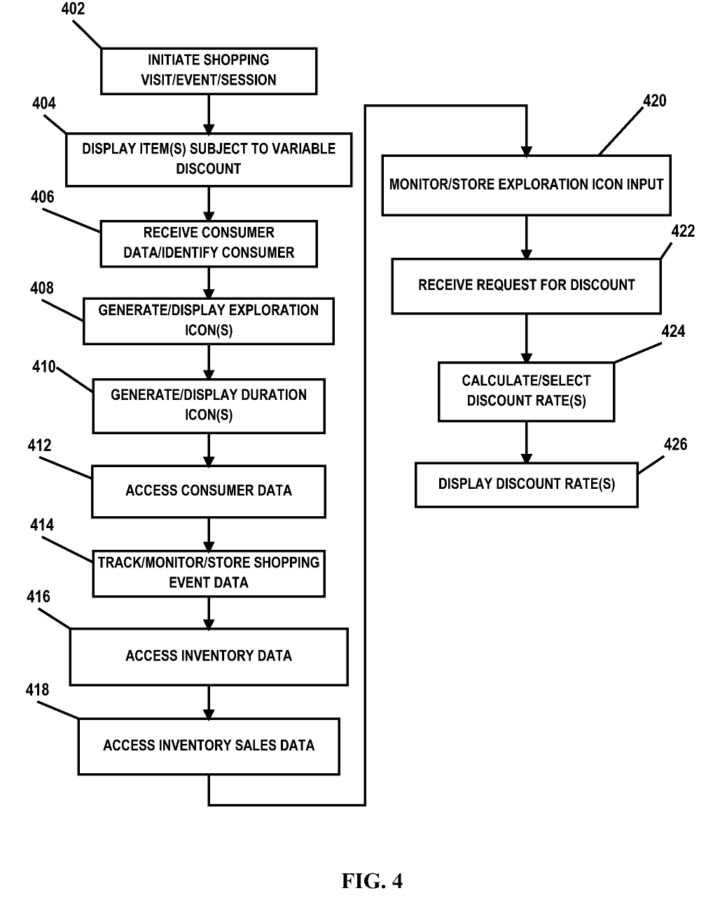

FIG. 4 is a flow diagram illustrating an embodiment of a variable discount method. The method begins at block 402, where a shopping event or session is initiated (e.g., via client 330 utilizing browser 332 to access vendor system 310). At block 404, item(s) subject to discounting is displayed. For example, discount module 324 may access item(s) discount 378 information and cause website interface 320 to display item(s) subject to discounts. At block 406, vendor system 310 receives information corresponding to the consumer of the shopping event (e.g., via a consumer login or otherwise). At block 408, website interface 320 generates and/or otherwise displays exploration icon(s) 372 on one or more website pages. At block 410, website interface 320 generates and/or otherwise displays duration icon(s) 380.

At block 412, discount module 324 accesses consumer data 358 (e.g., current shopping data 362, historical shopping data 364, return data 366, registry data 370, etc.). At block 414, discount module 324 and/or shopping module tracks, monitors and/or otherwise stores information relative to the shopping event (e.g., visit data 368, current shopping data 362, etc.). At block 416, discount module 324 accesses inventory data 354 (e.g., based on items placed in a shopping cart by the consumer). In some embodiments, discount module 324 may access inventory data 354 for a variety of different product items and automatically adjust the discount rates 376 for different items, select new product items to associate with a discount rate 376, and/or discontinue an associated discount rate. Thus, during the shopping event, discounts may be modified, added and/or discontinued for different product items. At block 418, discount module 324 accesses inventory sales data 356. In some embodiments, discount module 324 may access inventory sales data 356 for a variety of different product items and automatically adjust the discount rates 376 for different items, select new product items to associate with a discount rate 376, and/or discontinue an associated discount rate. Thus, during the shopping event, discounts may be modified, added and/or discontinued for different product items based on a rate of sales for particular product items.

At block 420, vendor system 310 monitors and/or stores consumer inputs relative to exploration icon(s) 372 (e.g., via website interface 320). At block 422, discount module 324 receives a request for application and/or the determination of a discount (e.g., a user may click on or select discount icon 380 to request the display or identification of a discount that may be applicable to one or more items). At block 424, discount module 324 calculates and/or otherwise selects one or more discount rate(s) 376 to apply to one or more indicated items. At block 426, discount module 324 causes website interface 320 to display and/or otherwise identify the determined discount rate(s) 376.

Thus, embodiments of the present disclosure enable an automatic and dynamic determination of discounts that may be associated and/or applied to one or more product items. Various types of criteria and/or variable may be evaluated relating to the consumer behavior (past and present), inventory levels and/or rate of sales of inventory to automatically and dynamically calculate/select a discount rate to associate with product items.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A dynamic variable discount system, comprising:
a shopping module executable by a processing unit to accumulate data corresponding to a shopping event of a consumer; and
a discount module executable by a processing unit to evaluate data corresponding to the shopping event and dynamically determine a discount to be applied to at least one item selected by the consumer during the shopping event.

2. The system of claim 1, wherein the discount module is configured to determine the discount in response to the consumer clicking on a discount icon displayed on a website associated with the shopping event.

3. The system of claim 1, wherein the discount module is configured to determine the discount based on a rate of sales for the item.

4. The system of claim 1, wherein the discount module is configured to determine the discount based on inventory data corresponding to the item.

5. The system of claim 1, wherein the discount module is configured to determine the discount based on a quantity of items stored in a shopping cart corresponding to the shopping event.

6. The system of claim 1, wherein the discount module is configured to determine the discount based on historical shopping data of the consumer.

7. The system of claim 1, wherein the discount module is configured to determine the discount based on historical item return data corresponding to the consumer.

8. The system of claim 1, wherein the discount module is configured to determine the discount based on a time period corresponding to the shopping event.

9. The system of claim 1, wherein the discount module is configured to determine the discount based on a quantity of website pages visited by the consumer during the shopping event.

10. The system of claim 1, wherein the discount module is configured to determine the discount based on a quantity of icon click inputs received from the consumer during the shopping event.

11. A dynamic variable discount method, comprising:
accumulating data corresponding to a website shopping event of a consumer;
storing the shopping event data in memory; and
responsive to receiving a discount request by the consumer, dynamically determining a discount to be applied to at least one item selected by the consumer during the shopping event.

12. The method of claim 11, further comprising determining the discount based on a rate of sales for the item.

13. The method of claim 11, further comprising determining the discount based on inventory data corresponding to the item, the inventory data indicating a quantity of the item residing in inventory available for sale.

14. The method of claim 11, further comprising determining the discount based on historical shopping data of the consumer.

15. The method of claim 11, further comprising determining the discount based on historical item return data corresponding to the consumer.

16. The method of claim 11, further comprising determining the discount based on a quantity of website pages visited by the consumer during the shopping event.

17. The method of claim 11, further comprising determining the discount based on a quantity of icon click inputs received from the consumer during the shopping event.

18. The method of claim 11, further comprising:
displaying a plurality of exploration icons;
tracking user click input of the exploration icons; and
determining the discount based on the user click input of the exploration icons.

19. The method of claim 11, further comprising:
displaying a duration icon indicating a duration of the shopping event; and
determining the discount based on the duration indicated by the duration icon.

20. The method of claim 11, further comprising:
displaying a discount icon;
responsive to a user selecting the discount icon, displaying a visual indication of the discount being variably determined; and
displaying the determined discount.

21. A computer program product for a dynamic variable discount system, the computer program product comprising:
a computer readable storage medium having computer readable program code embodied therewith, the computer readable program code comprising computer readable program code configured to:
access and analyze data corresponding to a website shopping event of a consumer; and
responsive to receiving a discount request by the consumer, dynamically selecting one from a plurality of different discount rates available to be applied to at least one item selected by the consumer during the shopping event.

22. The computer program product of claim 21, wherein the computer readable program code is configured to select the discount rate based on a rate of sales for the item.

23. The computer program product of claim 21, wherein the computer readable program code is configured to select the discount rate based on inventory data corresponding to the item, the inventory data indicating a quantity of the item residing in inventory available for sale.
